(19) United States
(12) Patent Application Publication
(10) Pub. No.: US 2006/0091170 A1
(43) Pub. Date: May 4, 2006

(54) LOAD CARRIER FOOT

(75) Inventor: Stefan ALMHIL, Taberg (SE)

Correspondence Address: NOVAK DRUCE & QUIGG, LLP, 1300 EYE STREET NW, 400 EAST TOWER, WASHINGTON, DC, 20005, US

(73) Assignee: THULE SWEDEN AB, Hillerstorp (SE)

(21) Appl. No.: 11/160,321

(22) Filed: Jun. 18, 2005

Related U.S. Application Data
(63) Continuation of application No. PCT/SE03/01832, filed on Nov. 27, 2003.

(30) Foreign Application Priority Data
Dec. 18, 2002 (SE) 0203734-9

(51) Int. Cl. B60R 9/00

(52) U.S. Cl. 224/325; 224/331

(57) ABSTRACT

A load carrier foot (5) for attaching a load carrier bar (6) to the roof edge area (4) of a vehicle (1) which is primarily a roof edge area above a door (3) of the vehicle. The roof edge area is provided with a first and a second mounting stud (38, 39). The load carrier foot (5) is provided with a foot part (8) to whose upper section (11) the load carrier bar (6) is attached and whose base section (13) is provided with a first and a second gripping device (14, 15) which are arranged so that they can be adjusted relative to each other between a first, retracted position (FIG. 5) in which they are fitted to the mounting studs for mounting the load carrier foot (5) on the roof edge area and a second, extended position (FIG. 4) in which they are moved into secure engagement with the mounting studs. The gripping devices are adjusted between the first and the second position by means of a tightening device (21) provided on the foot part (8) and in which at least one of the gripping devices (14, 15) is attached to a first link arm (16) that is pivotably mounted on the foot part (8) by means of a pivot pin (17).

### CROSS-REFERENCE TO RELATED APPLICATIONS

The present application is a continuation patent application of International Application No. PCT/SE2003/01832 filed 27 Nov. 2003 which was published in English pursuant to Article 21(2) of the Patent Cooperation Treaty, and which claims priority to Swedish Application No. 0203734-9 filed 18 Dec. 2002. Said applications are expressly incorporated herein by reference in their entireties.

### TECHNICAL FIELD

The present invention relates to a load carrier foot for attaching a load carrier bar to a roof edge area on a vehicle, primarily a roof edge area above a vehicle door, the roof edge area being provided with a first and a second mounting stud. The load carrier foot is provided with a foot part to whose upper section the load carrier bar is attached and whose base section is provided with a first and a second gripping device. The gripping devices can be adjusted relative to each other between a first, retracted position in which they are fitted to the mounting studs for the purpose of mounting the load carrier foot on the roof edge area and a second, extended position in which the gripping devices are adjusted to secure them to the mounting studs. The gripping devices are adjusted between the first and the second position by means of a tightening device on the foot part.

### BACKGROUND OF THE INVENTION

A load carrier foot of the type described above is typified in DE 37 29641 and SE 506852. However, the load carrier foot described in the German patent is provided with a foot part which, when mounted on the vehicle, is placed on a roof edge surface, primarily in the bottom of the drip rail which was formerly a common feature of cars, and in which the gripping devices are located on link arms mounted pivotably on the foot part and are secured to the mounting studs by means of a tightening device. The disadvantage of this earlier load carrier foot design is that if the roof edge surface and mounting studs are not matched relative to each other and to the load carrier foot, the foot may not be tightened securely enough when mounted on the vehicle. This may easily occur if a foot designed for one car model is used on another model for which it is not designed. The risk for this is greatest when the foot is mounted on a car model where the deviations are not of sufficient order to prevent the foot from being mounted without using excessive force. The problem may furthermore occur even if the foot is used on the correct car model since the relativity between the roof edge surface and the mounting studs may change as the vehicle is subjected to wear. A further disadvantage is that since link arms of the device are not attached to the foot part, other than by the pivoted mounting, the gripping devices can easily be twisted out of engagement with the mounting studs if the vehicle is subjected to severe braking (retardation), which can occur if the vehicle is involved in a collision.

The load carrier foot described in applicant's own SE 506852 shows a foot part which does not rest on a roof edge area, but is attached to the vehicle by tightening the gripping devices, which are integral with the foot part, to secure them to the mounting studs. This is achieved by the fact that the foot part of the load carrier foot is designed with a degree of inherent deformability which enables the device to be deformed by a tightening device in such manner that the gripping devices are brought into tightening contact with the mounting studs. A disadvantage of this load carrier foot, however, is that the deformability of the foot causes it to lose strength and become weak, with the result being that secure attachment may not be achieved with this foot, either.

Still further, both of these previously known load carrier feet suffer from the disadvantage that since the tightening devices are not blocked by any part of the vehicle when the vehicle doors are closed, they are accessible for actuation without any intervention to the vehicle on which they are mounted and can, therefore, be removed easily from the vehicle making it possible for unauthorized persons to remove the load carriers, with an load being carried, without great difficulty.

In view of the above, it becomes clear that a need exists for a load carrier foot of the type described above, but which is stable and whose link arms are attached securely to the foot part, and which can be mounted securely on the vehicle. Further, this foot design should minimize the risk of being mounted on a vehicle for which it is not designed, and whose tightening devices cannot be easily operated when the vehicle doors are closed.

### SUMMARY OF THE INVENTION

The present invention overcomes the disadvantages stated above by means of a load carrier foot of the type described in the introduction, and which is characterized in that at least one of the gripping devices is attached to a first link arm attached pivotably to the foot part.

In another aspect, the present invention is further characterized in that the first and the second gripping devices are respectively attached to a first and a second link arm, each of which is attached pivotably to the foot part.

The present invention is further characterized in that the actuating device for the tightening device is accessible only from the underside of the foot part.

Still further, the present invention is characterized in that the tightening device incorporates a linkage arrangement.

Further yet, the present invention is characterized in that each of the link arms passes through a slot in the base section of the foot part.

### BRIEF DESCRIPTION OF THE DRAWINGS

The invention will hereinafter be described with reference to a preferred embodiment, as shown in the accompanying drawings, of which:

FIG. 1 is an oblique perspective view of a vehicle with load carrier bars mounted thereupon;

FIG. 2 is a detailed view of a load carrier foot configured in accordance with the teachings of the present invention;

FIG. 3 is a detail view of a load carrier foot of FIG. 2 attached to a vehicle with the vehicle's door closed;

FIG. 4 is a view corresponding to FIG. 3, but with the vehicle door omitted;

FIG. 5 is a view corresponding to FIG. 4, but in which the foot is shown in an untightened configuration;

FIG. 6 is a cross-sectional view taken along line A-A in FIG. 3; and

FIG. 7 is a section-sectional view taken along line B-B in FIG. 4.

### DETAILED DESCRIPTION

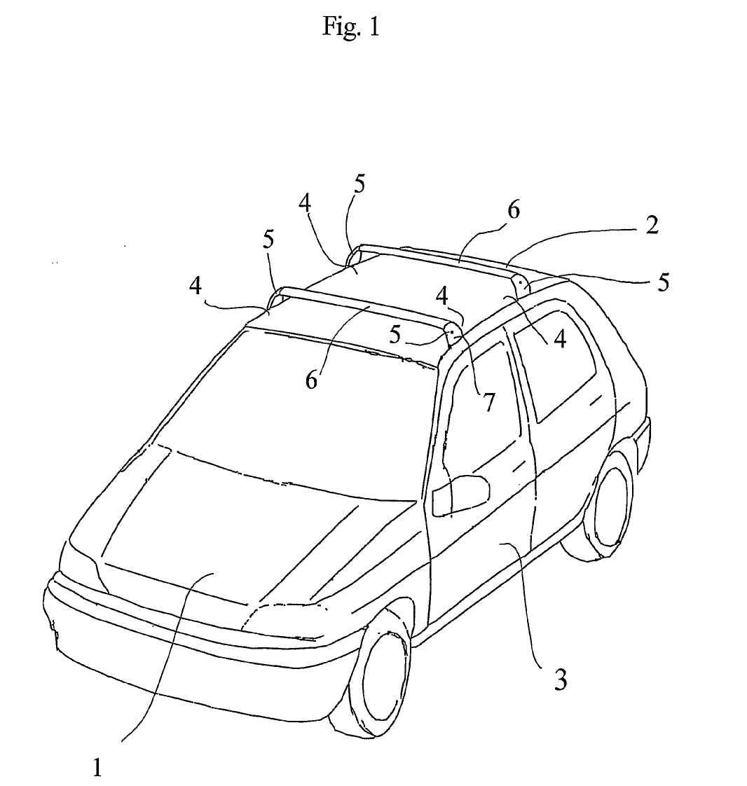

FIG. 1 shows a vehicle 1 having a roof 2 and doors 3. Load carrier feet 5 are mounted at edge areas 4 of the roof, and which are connected into pairs by load carrier bars 6 that extend across the roof 2.

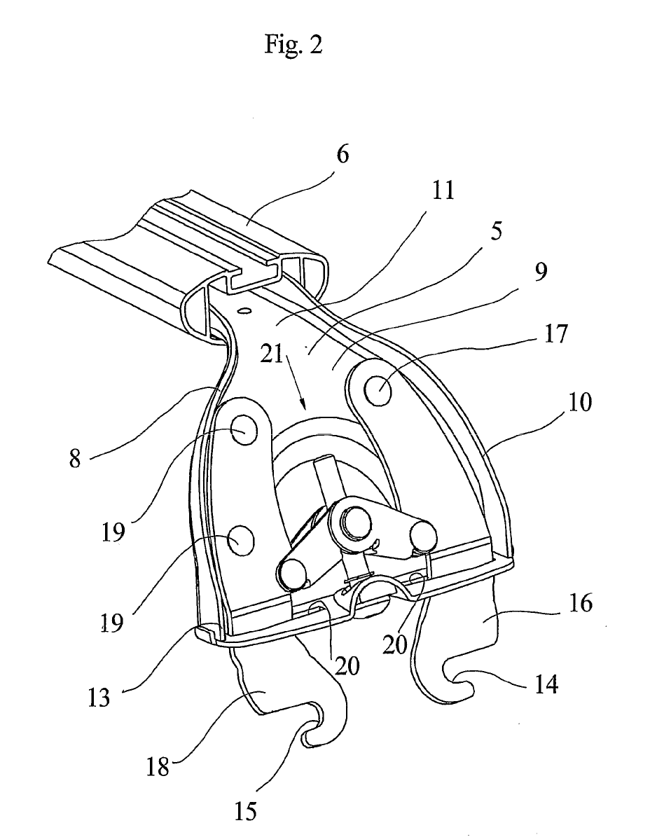

FIG. 2 is a detail view of a load carrier foot 5 configured in accordance with the teachings of present invention, and to which part of a load carrier bar 6 is connected. The foot cover 7, which is shown in FIG. 1 and which covers the internal workings of the load carrier foot, is omitted from FIG. 2. Since the cover 7 is only a design detail, it will not be further described.

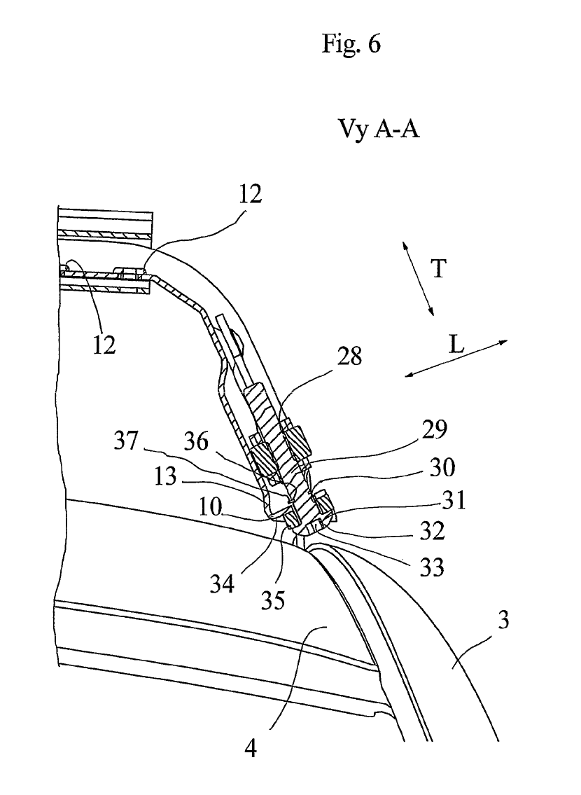

The load carrier foot 5 comprises (includes, but is not necessarily limited to) a foot part 8 provided with a flat section 9 bordered by a rim 10. At its upper end 11, the foot part 8 is attached to the load carrier bar 6 in a conventional manner by means of rivets 12 (see FIG. 6). The base section 13 of the foot part is provided with a first gripping device 14 and a second gripping device 15. The first gripping device 14 constitutes part of a first link arm 16 pivotably attached to the foot part 8 by means of a first pivot pin 17. The second gripping device 15 is connected to a second link arm 18 which is permanently attached, in known manner, to the foot part 8 by means of rivets 19. It will be clear to one skilled in the art that the arm 18 may comprise a part integral with the foot part 8, in which case it need not be attached to the foot part by rivets. To further ensure that the link arms 16 and 18 do not twist free of the foot part if the vehicle is involved in a collision, the arms pass through slots 20 in that part of the rim 10 extending along the base section 13 of the foot part. FIG. 2 also shows a tightening device 21.

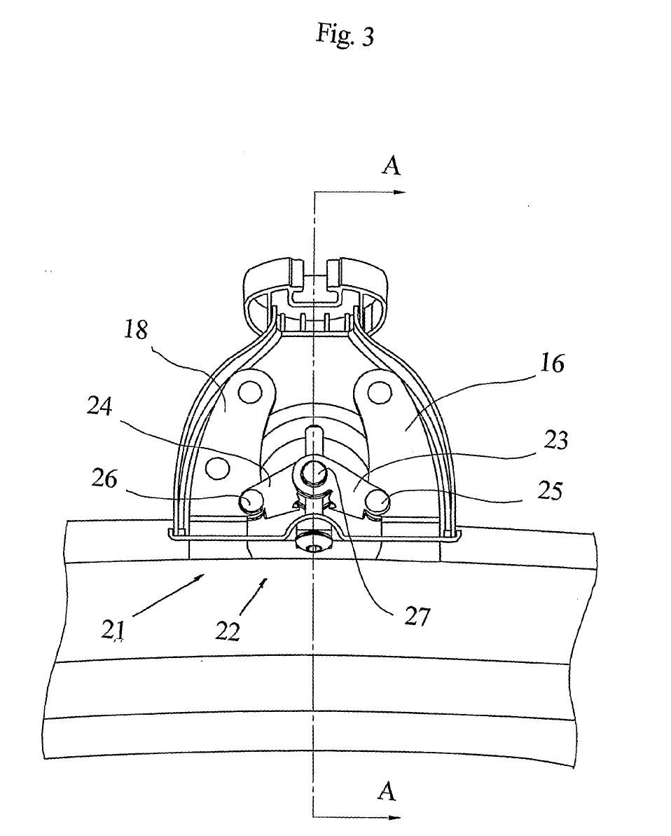

The construction and operation of the tightening device will be described in detail below with reference to FIGS. 3-6. As shown in those figures, the tightening device 21 incorporates a linkage 22 including a first link 23 and a second link 24. Link 23 is pivotably attached to the link arm 16 by a first pivot pin 25 and link 24 is pivotably attached to the link arm 18 by a second pivot pin 26. The links 23 and 24 are pivotably attached to each other by a link pin 27. The longitudinal direction of the link pin is indicated by the double-headed arrow L in FIG. 6. The pin is provided with a through, tapped hole 28 whose direction is indicated by the double-headed arrow T and, as shown in FIG. 6, this direction is substantially perpendicular to the longitudinal direction L.

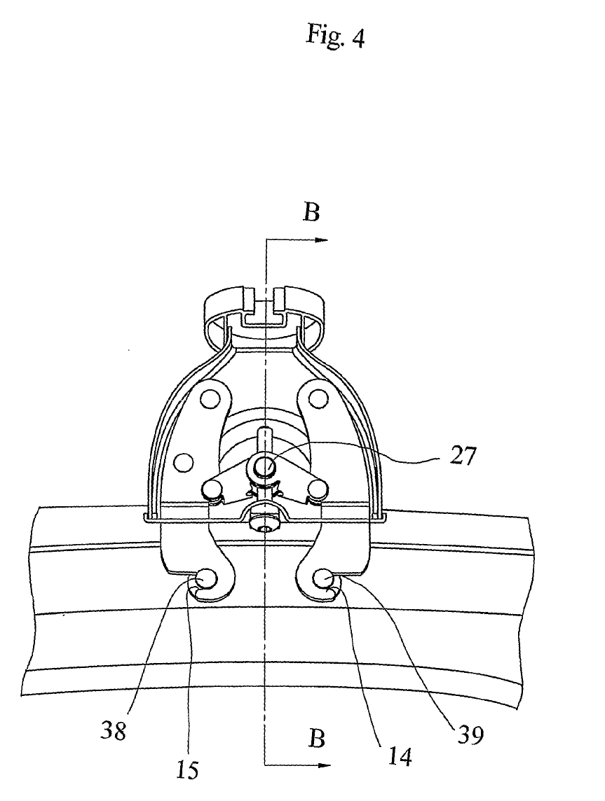

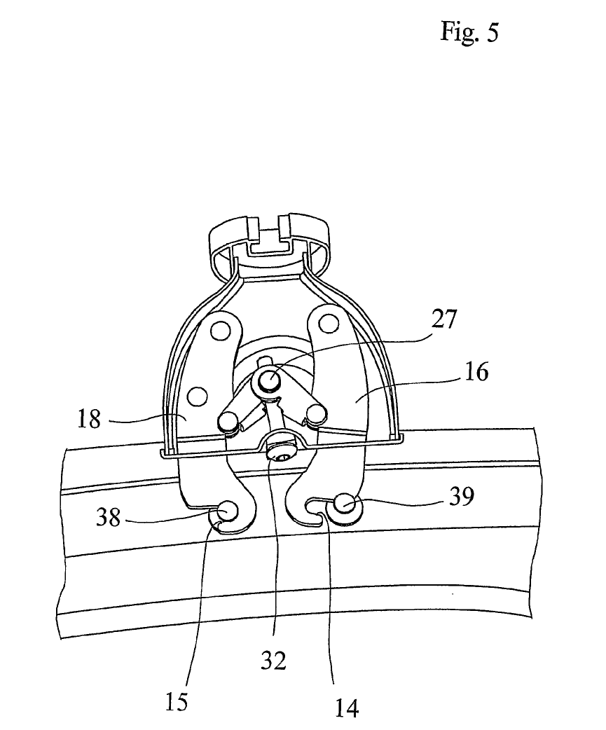

A tightening screw 29 is threaded through the tapped hole 28 and further extends through a hole 30 in the rim 10 which extends along the base section 13. The relationship between the tightening screw 29 and the hole 30 is such that the screw is free to turn in the hole. The tightening screw 29 is provided with an actuating device 31 consisting of a screw head 32 with an internal hexagon 33 for turning the tightening screw. As depicted in the figures, the actuating device 31 is accessible only from the underside 34 of the foot part 8. The section of the tightening screw 29 nearest the screw head 32 is unthreaded and a washer 35 is located between the screw head and the rim 10. The section of the screw 29 above the rim 10 is provided with a groove 36 in which a second washer 37 is seated. The washers 35 and 37 prevent the tightening screw 29 from moving axially relative to the rim 10 and the foot part 8 when the tightening screw is turned. Turning the tightening screw causes the link pin 27 to move along the tightening screw and causes the articulated joint, depending on the direction of rotation of the tightening screw, to either move the link arms towards each other to the position shown in FIG. 5 or away from each other to the position shown in FIG. 4.

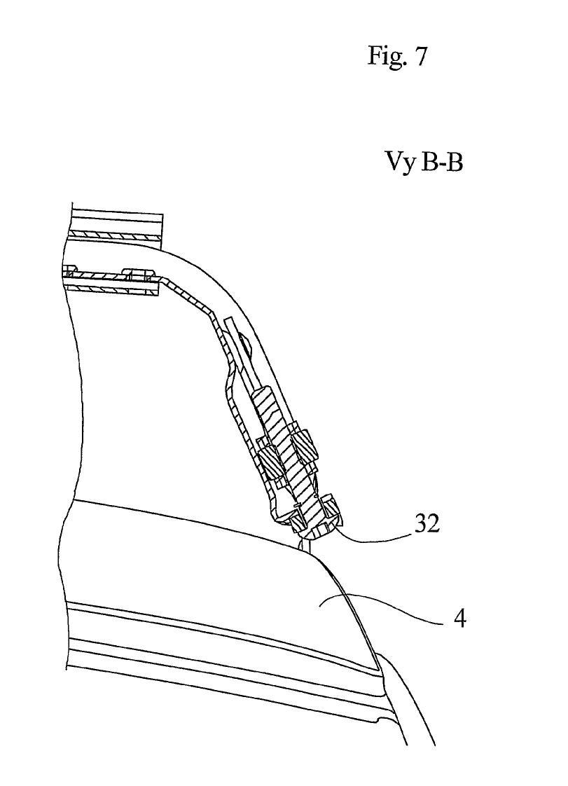

The mounting of the load carrier foot 5 on the edge area 4 of the vehicle roof will now be described in detail with reference to FIGS. 3-7. The link arms 16 and 18 are positioned as shown in FIG. 5 before the load carrier foot 5 is mounted on the roof. In this position, the gripping devices 14 and 15 are retracted towards each other. The roof edge area 4 is provided with a first and a second mounting stud 38 and 39, respectively, which are accessible when the vehicle door 3 is open. In FIG. 5, the vehicle door is swung into the open position and, as a result, is not visible in the figure; but in this position, the gripping devices 14 and 15 engage respectively with the mounting studs 38 and 39. The tightening screw 29 is then turned, and since the door 3 is open, the screw head 32 is easily accessible as is clear from FIG. 7, which is a view through section B-B in FIG. 4.

Rotation of the tightening screw 29 causes the link pin 27 of the articulated joint 22 to move downward in the direction of the screw head 32, thereby moving the link arms 16 and 18 relative to each other into the position shown in FIG. 4, in which position the gripping devices 14 and 15 are tightened securely against the studs 38 and 39, respectively. The door 3 is then closed and the gripping devices are concealed behind the door in the manner shown in FIG. 3, while the screw head 32 is blocked by the door 3 as shown in FIG. 6 thereby substantially eliminating the possibility of turning the screw head while the foot 5 is attached securely to the mounting studs.

Above and in the figures, the link arm 18 is described and shown as being permanently attached to the foot part 8 by means of rivets 19; however, it will be clear to one skilled in the art that this arm may also be attached pivotably to the foot part, preferably by means of a pivot pin in the same location as the upper rivet 19.

What is claimed is:

1. A load carrier foot (5) for attaching a load carrier bar (6) to the roof edge area (4) of a vehicle (1), primarily at a roof edge area above a vehicle door (3) and in which the roof edge area is provided with a first and a second mounting stud (38, 39), said load carrier foot (5) comprising:
a foot part (8) having an upper section (11) configured to be attached to a load carrier bar (6) and a base section (13) having a first and a second gripping device (14, 15) configured for adjustment relative to one another between a first, retracted position in which the first and second gripping devices (14, 15) are fitted to the mounting studs for mounting the load carrier foot (5) at the roof edge area of the vehicle, and a second, extended position in which the first and second gripping devices (14, 15) are adjusted to engage securely with the mounting studs. said the first and second gripping devices (14, 15) being adjusted between the first and the second positions by a tightening device (21) provided on the foot part (8); and
at least one of the gripping devices (14, 15) being attached to a first link arm (16) that is pivotably mounted on the foot part (8) by a pivot pin (17).

2. The load carrier foot (5) as recited in claim 1, wherein each gripping device (14, 15) is attached to a link arm (16, 18) which are individually mounted pivotably on the foot part (8).

3. The load carrier foot (5) as recited in claim 1, wherein an actuating device (31) for the tightening device (21) is accessible only from the underside (34) of the foot part (8).

4. The load carrier foot (5) as recited in claim 1, wherein tightening device (21) further comprises a linkage arrangement (22-33).

5. The load carrier foot (5) as recited in claim 1, wherein each link arm passes through a slot (20) in the base section (13) of the foot part (8).
